(19) United States
(12) Patent Application Publication
(10) Pub. No.: US 2026/0067977 A1
(43) Pub. Date: Mar. 5, 2026

(54) TECHNIQUES FOR HANDLING LOSS OF POSITIONING INFORMATION IN A CONNECTED STATE

(71) Applicant: QUALCOMM Incorporated, San Diego, CA (US)

(72) Inventors: Chiranjib SAHA, Lakeside, CA (US); Alberto RICO ALVARINO, San Diego, CA (US); Xiao Feng WANG, San Diego, CA (US)

(21) Appl. No.: 18/817,039

(22) Filed: Aug. 27, 2024

(51) Int. Cl. H04W 76/27; H04W 74/0833

(52) U.S. Cl. CPC H04W 76/27; H04W 74/0833

(57) ABSTRACT

Methods, systems, and devices for wireless communications are described. The described techniques provide for provide for a user equipment (UE) to operate according to one or more sub-states of a radio resource control (RRC) connected state when the UE loses positioning information, which may support the UE maintaining uplink synchronization with a network entity without transitioning to an RRC idle state. The UE may maintain one or more timers associated with operations in sub-states of the RRC connected state, and may use respective uplink synchronization parameters according to a current sub-state. For example, the UE may indicate location information status to the network entity and may receive resource adjustment parameters or random access channel (RACH) resources for determining resource adjustment values with or without location information.

### INTRODUCTION

The following relates to wireless communications, including techniques for handling loss of positioning information in a connected state.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications, a UE may adjust a timing of an uplink signal to align reception of the uplink signal at a network entity with a scheduled arrival time of the uplink signal. For example, the UE may apply a timing advance value to offset transmission of an uplink signal, which may account for propagation delays associated with transmitting the signal via a wireless channel.

### SUMMARY

The systems, methods, and devices of this disclosure each have several innovative aspects, no single one of which is solely responsible for the desirable attributes disclosed herein.

A method for wireless communication by a first network entity is described. The method may include operating in a radio resource control (RRC) connected state with a second network entity, determining that location information associated with the first network entity is unavailable, initiating a first timer based on a determination that the location information is unavailable, transitioning to a first sub-state of the RRC connected state from a second sub-state of the RRC connected state based on expiration of the first timer, where the first sub-state is associated with the location information being unavailable and the second sub-state is associated with the location information being available, and communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

A first network entity for wireless communication is described. The first network entity may include one or more memories storing processor executable code, and one or more processors coupled with the one or more memories. The one or more processors may individually or collectively be operable to execute the code to cause the first network entity to operate in an RRC connected state with a second network entity, determine that location information associated with the first network entity is unavailable, initiate a first timer based on a determination that the location information is unavailable, transition to a first sub-state of the RRC connected state from a second sub-state of the RRC connected state based on expiration of the first timer, where the first sub-state is associated with the location information being unavailable and the second sub-state is associated with the location information being available, and communicate with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

Another first network entity for wireless communication is described. The first network entity may include means for operating in an RRC connected state with a second network entity, means for determining that location information associated with the first network entity is unavailable, means for initiating a first timer based on a determination that the location information is unavailable, means for transitioning to a first sub-state of the RRC connected state from a second sub-state of the RRC connected state based on expiration of the first timer, where the first sub-state is associated with the location information being unavailable and the second sub-state is associated with the location information being available, and means for communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

A non-transitory computer-readable medium storing code for wireless communication is described. The code may include instructions executable by one or more processors to operate in an RRC connected state with a second network entity, determine that location information associated with the first network entity is unavailable, initiate a first timer based on a determination that the location information is unavailable, transition to a first sub-state of the RRC connected state from a second sub-state of the RRC connected state based on expiration of the first timer, where the first sub-state is associated with the location information being unavailable and the second sub-state is associated with the location information being available, and communicate with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

Some examples of the method, first network entities, and non-transitory computer-readable medium described herein may further include operations, features, means, or instructions for receiving configuration information that indicates a first set of time-frequency adjustment parameters associated with the first uplink synchronization procedure and a second set of time-frequency adjustment parameters associated with a second uplink synchronization procedure, where the second uplink synchronization procedure may be configured for use by the first network entity to maintain the uplink synchronization with the second network entity while the first network entity operates in the second sub-state of the RRC connected state.

Some examples of the method, first network entities, and non-transitory computer-readable medium described herein may further include operations, features, means, or instructions for receiving configuration information that indicates a duration of the first timer, where the duration may be common to a set of one or more network entities that includes the first network entity or the duration may be configured in accordance with one or more capabilities of the first network entity.

Some examples of the method, first network entities, and non-transitory computer-readable medium described herein may further include operations, features, means, or instructions for transmitting, to the second network entity and prior to the expiration of the first timer, a first message that indicates that the location information associated with the first network entity may be unavailable.

Some examples of the method, first network entities, and non-transitory computer-readable medium described herein may further include operations, features, means, or instructions for receiving an uplink synchronization adjustment command from the second network entity based on transmission of the first message, where communicating with the second network entity in accordance with the first uplink synchronization procedure includes and communicating one or more uplink signals via one or more slots in accordance with a first timing advance adjustment and a first frequency adjustment indicated by the uplink synchronization adjustment command.

In some examples of the method, first network entities, and non-transitory computer-readable medium described herein, communicating the one or more uplink signals may include operations, features, means, or instructions for determining the first timing advance adjustment and the first frequency adjustment according to a feedback loop, where the feedback loop may be initialized based on a second timing advance adjustment and a second frequency adjustment used prior to the determination that the location information may be unavailable.

Some examples of the method, first network entities, and non-transitory computer-readable medium described herein may further include operations, features, means, or instructions for receiving, from the second network entity and based on transmission of the first message, a second message that includes a command to perform a random access procedure via a first set of time-frequency resources, where the first set of time-frequency resources may be associated with a physical random access channel (PRACH) configured for operations in the first sub-state of the RRC connected state.

Some examples of the method, first network entities, and non-transitory computer-readable medium described herein may further include operations, features, means, or instructions for initiating a second timer based on transmission of the first message, determining, prior to expiration of the second timer and while the first network entity operates in the first sub-state of the RRC connected state, that the location information may be available, and transmitting, to the second network entity, a second message that indicates that the location information may be available based on the determination that the location information may be available and expiration of the second timer.

Some examples of the method, first network entities, and non-transitory computer-readable medium described herein may further include operations, features, means, or instructions for refraining from transmission of the second message based on the second timer not being expired.

Some examples of the method, first network entities, and non-transitory computer-readable medium described herein may further include operations, features, means, or instructions for receiving, from the second network entity and based on transmission of the second message, a third message that includes a timing adjustment associated with the second uplink synchronization procedure.

Some examples of the method, first network entities, and non-transitory computer-readable medium described herein may further include operations, features, means, or instructions for receiving, from the second network entity and based on transmission of the second message, a third message that includes a command to perform a random access procedure via a second set of time-frequency resources, where the second set of time-frequency resources may be associated with a PRACH configured for operations in the second sub-state of the RRC connected state.

In some examples of the method, first network entities, and non-transitory computer-readable medium described herein, communicating with the second network entity in accordance with the first uplink synchronization procedure may include operations, features, means, or instructions for determining a first timing advance for communication of an uplink signal based on a second timing advance used prior to the determination that the location information may be unavailable.

Some examples of the method, first network entities, and non-transitory computer-readable medium described herein may further include operations, features, means, or instructions for determining that a second timer associated with the uplink synchronization between the first network entity and the second network entity may have expired, determining that radio link failure (RLF) may have occurred at the first network entity, and performing a random access procedure via a first set of time-frequency resources based on the RLF.

Some examples of the method, first network entities, and non-transitory computer-readable medium described herein may further include operations, features, means, or instructions for obtaining one or more measurements from a non-terrestrial navigation network, where the determination that the location information may be unavailable may be based on the one or more measurements.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for handling loss of positioning information in a connected state in accordance with one or more aspects of the present disclosure.

FIG. 2 shows an example of a wireless communications system that supports techniques for handling loss of positioning information in a connected state in accordance with one or more aspects of the present disclosure.

FIG. 3 shows an example of a process flow that supports techniques for handling loss of positioning information in a connected state in accordance with one or more aspects of the present disclosure.

FIGS. 4 and 5 show block diagrams of devices that support techniques for handling loss of positioning information in a connected state in accordance with one or more aspects of the present disclosure.

FIG. 6 shows a block diagram of a communications manager that supports techniques for handling loss of positioning information in a connected state in accordance with one or more aspects of the present disclosure.

FIG. 7 shows a diagram of a system including a device that supports techniques for handling loss of positioning information in a connected state in accordance with one or more aspects of the present disclosure.

FIG. 8 shows a flowchart illustrating methods that support techniques for handling loss of positioning information in a connected state in accordance with one or more aspects of the present disclosure.

### DETAILED DESCRIPTION

Wireless communications systems may support devices communicating via wireless channels, which may include the devices adjusting time-frequency resource allocations to align transmissions. For example, a user equipment (UE) may use a positioning system, such as a global navigation satellite system (GNSS), to support timing and frequency correction for uplink communications, such as to account for time delays incurred by propagating a signal via a physical medium (e.g., a time for the signal to travel from the UE to a network entity). In some cases, the UE may calculate a timing advance (e.g., a time domain offset) for an uplink signal according to an adjustment value that is based on a measurement from the GNSS. To communicate in some wireless networks, for example a non-terrestrial network (NTN), a network entity may assume or otherwise account for the UE having an available GNSS connection for applying resource correction to uplink signals. For example, if the UE identifies that location information for the UE is unavailable (e.g., the UE loses connection to the GNSS) while in a radio resource control (RRC) connected state with the network entity, the UE may lose uplink synchronization with the network entity and transition to an RRC idle state. However, such RRC state transitions and subsequent reconnection procedures (e.g., a random access channel (RACH) procedure) may be associated with additional signaling overhead and latency, particularly when the UE would otherwise be able to continue communicating with the network entity despite the location information being unavailable. Additionally, the UE may regain the GNSS connection relatively soon after losing the GNSS connection, but may be unable to reestablish uplink synchronization with the network entity without transitioning to the RRC idle state and performing an RRC idle RACH procedure.

Techniques described herein generally provide for a UE to operate according to one or more sub-states of an RRC connected state when the UE loses a GNSS connection, which may support the UE reestablishing uplink synchronization with a network entity without transitioning to an RRC idle state. For example, the UE may be configured to apply a first uplink synchronization procedure when GNSS is unavailable and may be configured to apply a second uplink synchronization procedure when GNSS is available. In some cases, the UE may maintain one or more timers associated with operations in sub-states of the RRC connected state. For example, the UE may operate in a GNSS-available sub-state of the RRC connected state prior to losing location information, and may initiate a first timer in response to losing the location information (e.g., a GNSSValidityTimer). During a duration that the first timer is running, the UE may transmit an indication to the network entity that the location information is unavailable, and after expiration of the first timer, the UE may transition to a GNSS-unavailable sub-state of the RRC connected state. While operating in the GNSS-unavailable sub-state, if the UE detects that the location information is available (e.g., the UE regains the GNSS connection), the UE may transmit an indication to the network entity that the location information is available. In some cases, based on receiving an indication of the GNSS connection status from the UE, the network entity may transmit control signaling to the UE to support subsequent communications by the UE in accordance with the GNSS connection status. For example, if the UE indicates the location information is available, the network entity may indicate a timing advance command for the UE to apply for one or more subsequent slots, or may transmit a command to perform a random access procedure using time-frequency resources configured for the GNSS-available sub-state (e.g., the second uplink synchronization procedure). Alternatively, if the UE indicates the GNSS connection is unavailable, the network entity may indicate an uplink synchronization adjustment command including timing advance and frequency adjustment values for the UE to apply for one or more subsequent slots, or may transmit a command to perform a random access procedure using time-frequency resources configured for the GNSS-unavailable sub-state (e.g., the first uplink synchronization procedure). Such techniques may support the UE reestablishing uplink synchronization with the network entity when location information is unavailable, which may improve communications by the UE when location information is unavailable.

Aspects of the disclosure are initially described in the context of wireless communications systems and a process flow. Aspects of the disclosure are further illustrated by and described with reference to apparatus diagrams, system diagrams, and flowcharts that relate to techniques for handling loss of positioning information in a connected state.

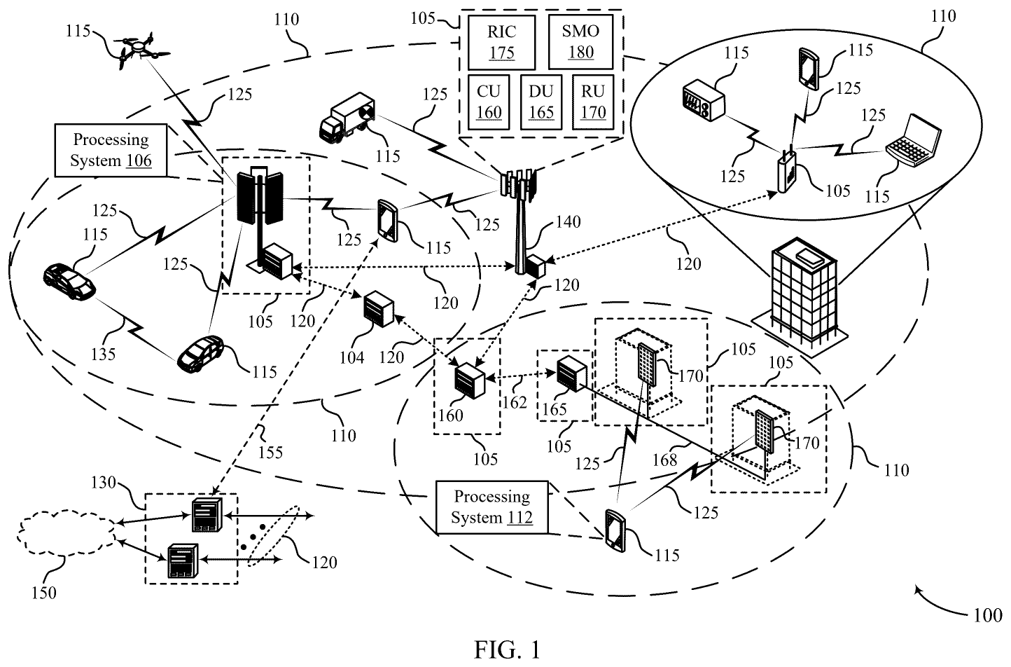

FIG. 1 shows an example of a wireless communications system 100 that supports techniques for handling loss of positioning information in a connected state in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity.

Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, a UE 115 may use a positioning system, such as a GNSS, to support timing and frequency correction for uplink communications, such as to account for time delays incurred by propagating a signal via a physical medium (e.g., a time for the signal to travel from the UE 115 to a network entity 105). In some cases, the UE 115 may calculate a timing advance (e.g., a time domain offset) for an uplink signal according to an adjustment value that is based on one or more measurements from the GNSS. To communicate in some wireless networks, for example an NTN, a network entity 105 may assume or otherwise account for the UE 115 having an available GNSS connection for applying resource correction to uplink signals. For example, if the UE 115 identifies that location information for the UE 115 is unavailable (e.g., the UE 115 loses connection to the GNSS) while in a RRC connected state with the network entity 105, the UE 115 may lose uplink synchronization with the network entity 105 and transition to an RRC idle state. However, such RRC state transitions and subsequent reconnection procedures (e.g., a RACH procedure) may be associated with additional signaling overhead and latency, particularly when the UE 115 would otherwise be able to continue communicating with the network entity 105 despite the location information being unavailable. Additionally, the UE 115 may regain the GNSS connection relatively soon after losing the GNSS connection, but may be unable to reestablish uplink synchronization with the network entity 105 without transitioning to the RRC idle state and performing an RRC idle RACH procedure.

Techniques described herein provide for a UE 115 to operate according to one or more sub-states of an RRC connected state when the UE 115 loses a GNSS connection, which may support the UE 115 reestablishing uplink synchronization with a network entity 105 without transitioning to an RRC idle state. For example, the UE may be configured to apply a first uplink synchronization procedure when GNSS is unavailable and may be configured to apply a second uplink synchronization procedure when GNSS is available. In some cases, the UE 115 may maintain one or more timers associated with operations in sub-states of the RRC connected state. For example, the UE 115 may operate in a GNSS-available sub-state of the RRC connected state prior to losing location information, and may initiate a first timer in response to losing the location information (e.g., a GNSSValidityTimer). During a duration that the first timer is running, the UE 115 may transmit an indication to the network entity 105 that the location information is unavailable, and after expiration of the first timer, the UE 115 may transition to a GNSS-unavailable sub-state of the RRC connected state. While operating in the GNSS-unavailable sub-state, if the UE 115 detects that the location information is available (e.g., the UE regains the GNSS connection), the UE 115 may transmit an indication to the network entity 105 that the location information is available. In some cases, based on receiving an indication of the GNSS connection status from the UE 115, the network entity 105 may transmit control signaling to the UE 115 to support subsequent communications by the UE 115 in accordance with the GNSS connection status. For example, if the UE 115 indicates the location information is available, the network entity 105 may indicate a timing advance command for the UE 115 to apply for one or more subsequent slots, or may transmit a command to perform a random access procedure using time-frequency resources configured for the GNSS-available sub-state (e.g., the second uplink synchronization procedure). Alternatively, if the UE 115 indicates the GNSS connection is unavailable, the network entity 105 may indicate an uplink synchronization adjustment command including timing advance and frequency adjustment values for the UE 115 to apply for one or more subsequent slots, or may transmit a command to perform a random access procedure using time-frequency resources configured for the GNSS-unavailable sub-state (e.g., the first uplink synchronization procedure). Such techniques may support the UE 115 reestablishing uplink synchronization with the network entity 105 when location information becomes unavailable, which may improve communications by the UE 115 when location information is unavailable.

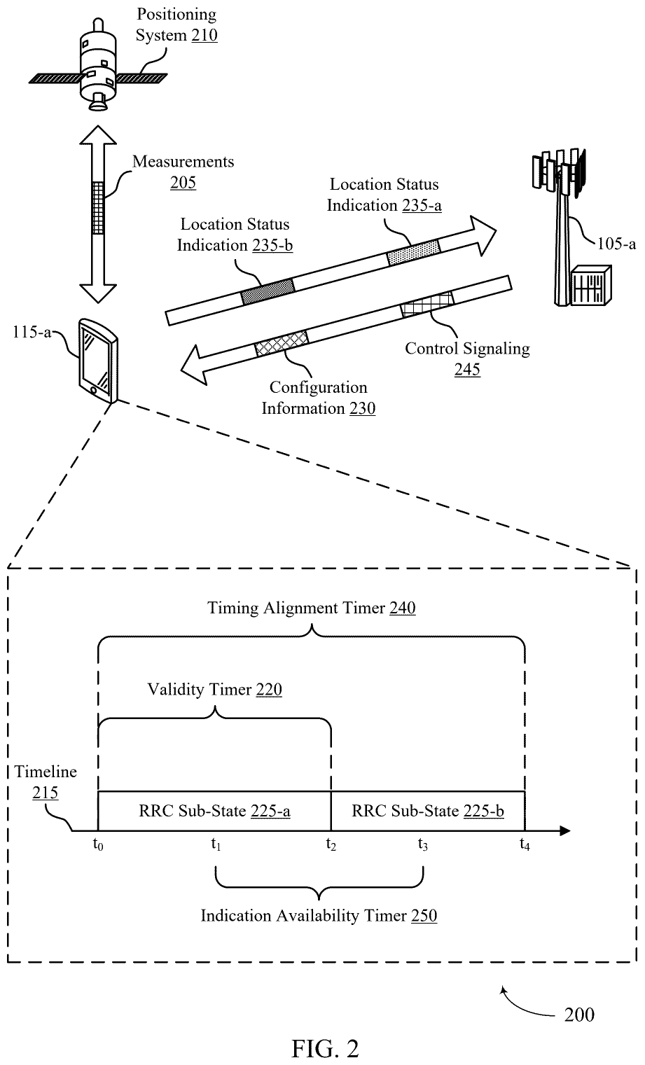

FIG. 2 shows an example of a wireless communications system 200 that supports techniques for handling loss of positioning information in a connected state in accordance with one or more aspects of the present disclosure. The wireless communications system 200 may implement, or be implemented by, one or more aspects of the wireless communications system 100. For example, the wireless communications system 200 illustrates communications and operations of a UE 115-a and a network entity 105-a, which may be examples of corresponding devices described with reference to FIG. 1. In some cases, the UE 115-a may include or support operation of a position engine, which may be configured to obtain measurements from a positioning system, such as a GNSS, that supports identifying a physical location of the UE 115-a. The wireless communications system 200 may support the UE 115-a operating in one or more sub-states of an RRC connected state according to an availability of location information at the UE 115-a.

In some examples, the UE 115-a may operate in an RRC connected state with the network entity 105-a. For example, the UE 115-a may establish a connection with the network entity 105-a and may perform a RACH procedure to gain access to a wireless channel between the UE 115-a and the network entity 105-a (e.g., the UE 115-a may be RRC connected while having access to the channel). While operating in the RRC connected state, the UE 115-a may maintain uplink synchronization with the network entity 105-a, which may include applying timing and frequency corrections to uplink transmissions (e.g., physical random access channel (PRACH) transmissions, physical uplink control channel (PUCCH) transmissions, physical uplink shared channel (PUSCH) transmissions, sounding reference signal (SRS) transmissions, or the like). Such corrections may support the UE 115-a adjusting a time domain location, a frequency domain location, or both for an uplink transmission, for example to account for propagation delays associated with communicating the uplink transmission.

To identify time-frequency adjustment parameters for an uplink transmission, the UE 115-a may obtain one or more measurements 205 from a positioning system 210 (e.g., GNSS, or any other suitable satellite positioning system) to determine location information of the UE 115-a. For example, the UE 115-a may include a position engine configured to obtain the measurements 205 from the positioning system 210 and identify, according to the measurements 205, a physical location of the UE 115-a. The UE 115-a may use the location information to determine (e.g., calculate) the time-frequency adjustment parameters, which may include a timing advance value, a frequency adjustment value, or both (e.g., resource offset values). Due to the positioning system 210 providing the UE 115-a with the location information used to maintain uplink synchronization, the network entity 105-a may assume or otherwise expect that the UE 115-a has available location information when communicating uplink transmissions, particularly when the network entity 105-a is part of a NTN.

As such, if the UE 115-a loses connection to the positioning system 210 (e.g., loses GNSS), the UE 115-a may lose uplink synchronization with the network entity 105-a and may transition to an RRC idle state (e.g., after expiration of a timing advance timer associated with the uplink synchronization). In such examples, the UE 115-a may perform another RACH procedure to transition to the RRC connected state. However, such RRC state transitions and reconnection procedures may be associated with additional signaling overhead and latency, particularly when the UE 115-a would otherwise be able to continue communicating with the network entity 105-a despite the location information being unavailable. Additionally, the UE 115-a may regain the GNSS connection relatively soon after losing the GNSS connection, but may be unable to reestablish uplink synchronization with the network entity 105-a without transitioning to the RRC idle state and performing an RRC idle RACH procedure.

In some examples, the UE 115-a may operate according to one or more sub-states of the RRC connected state according to the availability of location information at the UE 115-a, and may perform different uplink synchronization procedures for each sub-state. The timeline 215 shows an example of sub-state transitions and associated timers at the UE 115-a according to the availability of the location information. For example, at t₀ of the timeline 215, the UE 115-a may determine that the location information is unavailable (e.g., the UE 115-a may fail to obtain measurements 205 from the positioning system 210), and the UE 115-a may initiate a validity timer 220 (e.g., GNSSValidityTimer) in response to the location information being unavailable. In some examples, the UE 115-a may determine a duration of the validity timer 220 based on signaling from the network entity 105-a. For example, the UE 115-a may receive configuration information 230 from the network entity 105-a that indicates the duration of the validity timer 220. In some cases, the UE 115-a may receive the configuration information 230 as a system information block (SIB) including the duration indication, where the duration may be common to one or more other UEs 115 (e.g., GNSSValidityTimerCommon, a common value for idle mode UEs 115 to choose PRACH resources). In some other cases, the UE 115-a may receive the configuration information 230 as a RRC control signal including the duration indication, where the duration may be specific to the UE 115-a based on capabilities of the UE 115-a (e.g., GNSSValidityTimerDedicated). Alternatively, the UE 115-a may determine the duration of the validity timer 220 autonomously or dynamically (e.g., according to implementation of the UE 115-a).

In some cases, while the validity timer 220 is running, the UE 115-a may operate in an RRC sub-state 225-a, which may be associated with the location information being available (e.g., a GNSS-available sub-state, which may be referred to as a second sub-state). For example, due to the loss of location information being relatively recent, the UE 115-a may still be able to use previous measurements 205 to determine relatively accurate timing and frequency adjustment values. Additionally, or alternatively, while the validity timer 220 is running, the UE 115-a may transmit a location status indication 235-a (e.g., a MAC-CE, a UCI message) to the network entity 105-a indicating that the location information is unavailable. For example, the UE 115-a may transmit the location status indication 235-a at t₁ of the timeline 215, which may occur at any point while the validity timer 220 is active, and is not limited to the example illustrated by the wireless communications system 200. In some cases, the UE 115-a may transmit the location status indication 235-a based on the UE 115-a having a valid timing advance, which may be indicated by a timing alignment timer 240 being active. For example, if the timing alignment timer 240 expires after the UE 115-a loses location information, the UE 115-a may follow a standard uplink synchronization procedure for an uplink carrier by performing a RACH procedure.

In some cases, the UE 115-a may maintain uplink synchronization with the network entity 105-a after transmitting the location status indication 235-a. For example, while the validity timer 220 is active (e.g., the UE 115-a may maintain uplink synchronization), if the UE 115-a has transmitted the location status indication 235-a indicating that the location information is unavailable and has not received a response from the network entity 105-a, the UE 115-a may continue to compute timing advance values using a last-computed timing advance value (e.g., the UE 115-a may maintain an approximate synchronization despite losing GNSS connection).

Additionally, or alternatively, the UE 115-a may receive control signaling 245 from the network entity 105-a in response to the location status indication 235-a. In some cases, the control signaling 245 may include an uplink synchronization adjustment command. The uplink synchronization adjustment command may include time-frequency adjustment parameters, such as a timing advance adjustment value, a frequency adjustment value, or both for the UE 115-a to use for maintaining uplink synchronization for one or more slots while the UE 115-a does not have available location information. For example, the uplink synchronization adjustment command may indicate a first valid slot for applying the time-frequency adjustment parameters, and the UE 115-a may switch, at the first slot and for one or more subsequent slots, from applying GNSS-based time-frequency adjustment and core doppler compensation to applying the time-frequency adjustment parameters indicated by the uplink synchronization adjustment command. In such examples, the UE 115-a may use feedback loops for applying the time-frequency adjustment parameters indicated by the uplink synchronization adjustment command, where the feedback loops may be initialized based on a timing advance adjustment value, a frequency adjustment value, or both from last-known GNSS measurements obtained by the UE 115-a (e.g., the indicated time-frequency adjustment values and the last-known GNSS-based adjustment values may each be used to compute the appropriate adjustment values). Additionally, in such examples, the UE 115-a may stop running the validity timer 220, and may continue to operate in the RRC sub-state 225-a (e.g., the UE 115-a may continue to operate as if location information is available due to receiving the uplink synchronization adjustment command).

In some examples, after expiration of the validity timer 220, the UE 115-a may transition to an RRC sub-state 225-b from the RRC sub-state 225-a. The RRC sub-state 225-b may be associated with the location information being unavailable (e.g., a GNSS-unavailable sub-state, which may be referred to as a first sub-state of the RRC connected state). In some cases, while operating in the RRC sub-state 225-b, the UE 115-a may receive control signaling 245 (e.g., instead of or in addition to receiving the control signaling 245 while operating in the RRC sub-state 225-a). In such examples, the control signaling 245 may include a command to perform a RACH procedure using a first set of time-frequency resources associated with a PRACH. For example, the control signaling 245 may be a PDCCH order to perform the RACH procedure using the first set of time-frequency resources, where the first set of time-frequency resources may be associated with the RRC sub-state 225-b (e.g., GNSS-unavailable PRACH resources). In some cases, the first set of time-frequency resources may be indicated (e.g., in advance) by the configuration information 230. By performing the RACH procedure according to the PRACH resources configured for unavailable location information, the UE 115-a may maintain uplink synchronization without leaving the RRC connected state. For example, the UE 115-a may transition back to the RRC sub-state 225-a after performing the RACH procedure.

In some cases, while operating in the RRC sub-state 225-b, the UE 115-a may determine that the location information is available (e.g., the UE 115-a may regain connection to the GNSS). The UE 115-a may transmit a location status indication 235-b (e.g., a MAC-CE, a UCI message) to the network entity 105-a indicating that the location information is available. In some cases, the UE 115-a may maintain an indication availability timer 250 (e.g., GNSS-availability-indication-timer, which may be configured by the network entity 105-a) indicating a duration between transmitting location status indications 235. For example, to avoid excessive location status reporting (e.g., preventing ‘ping-pong’ reporting should GNSS frequently switch between available and unavailable), the UE 115-a may initiate the indication availability timer 250 after transmitting the location status indication 235-a, and may refrain from transmitting the location status indication 235-b until the indication availability timer 250 has elapsed. For example, the UE 115-a may transmit the location status indication 235-b at or after t₃ of the timeline 215, where t₃ may occur after t₁ according to a duration of the indication availability timer 250. In some cases, the UE 115-a may re-initiate the indication availability timer 250 after transmitting the location status indication 235-b.

In some cases, the network entity 105-a may transmit the control signaling 245 to the UE 115-a based on receiving the location status indication 235-b indicating that the location information is available. For example, the control signaling 245 may include a timing advance command indicating a timing adjustment associated with the location information being available (e.g., associated with GNSS-based timing adjustment). The control signaling 245 may indicate a first valid slot for the UE 115-a to apply the timing adjustment, such that the UE 115-a may apply GNSS-based timing adjustment at the first valid slot and one or more subsequent slots. Additionally, or alternatively, the control signaling 245 may include a PDCCH order to perform a RACH procedure using a second set of time-frequency resources that are associated with the location information being available (e.g., PRACH resources associated with the RRC sub-state 225-a). In some cases, the second set of time-frequency resources may be indicated (e.g., in advance) by the configuration information 230 (e.g., the configuration information 230 may indicate the first set of time-frequency resources and the second set of time-frequency resources for the UE 115-a to use for performing the RACH procedure in the RRC sub-state 225-a and the RRC sub-state 225-b, respectively). Alternatively, the UE 115-a may perform the RACH procedure using the second set of time-frequency resources autonomously (e.g., without the PDCCH order) based on the validity timer 220 expiring and transitioning to the RRC sub-state 225-b.

In some examples, if the timing alignment timer 240 expires (e.g., the UE 115-a is unable to maintain uplink synchronization and refresh the timing alignment timer 240), the UE 115-a may declare radio link failure (RLF), and may perform a RACH procedure using time-frequency resources associated with location information being unavailable.

By operating in the different RRC sub-states 225 and maintaining timers supporting transitions between the RRC sub-states 225, the UE 115-a may support two methods for uplink synchronization, one according to GNSS being unavailable and one according to GNSS being available. Such techniques may support the UE 115-a switching between the RRC sub-states 225 according to the timers and indications from the network entity 105-a, which may support the UE 115-a maintaining uplink synchronization without transitioning from the RRC connected state even when location information is unavailable.

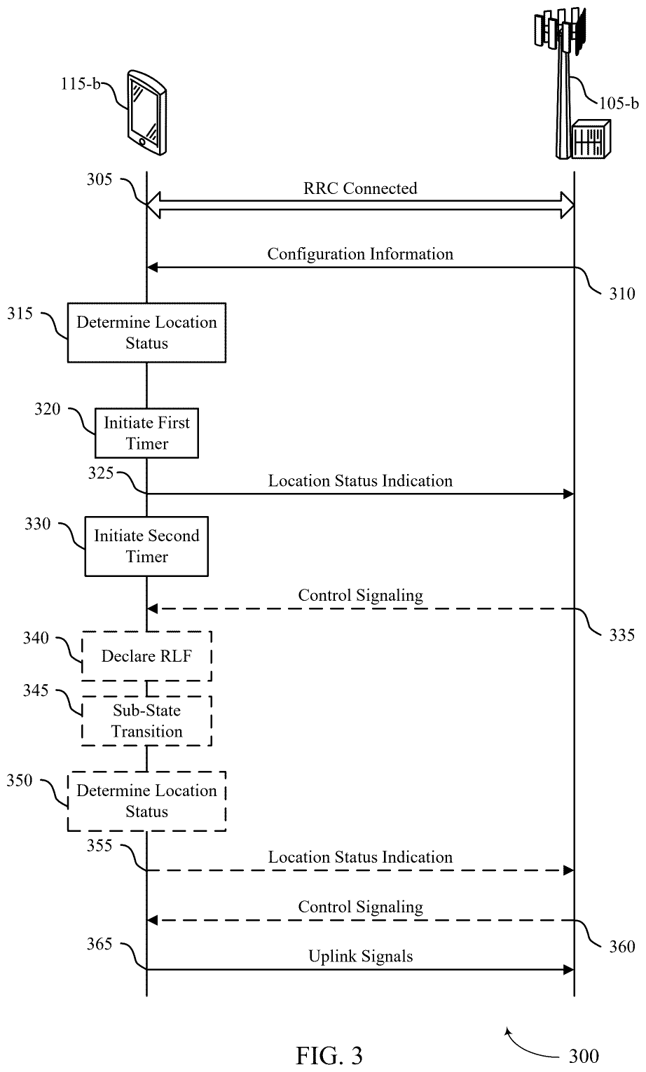

FIG. 3 shows an example of a process flow 300 that supports techniques for handling loss of positioning information in a connected state in accordance with one or more aspects of the present disclosure. The process flow 300 may implement, or be implemented by, one or more aspects of the wireless communications systems 100 and 200. For example, the process flow 300 illustrates signaling and operations of a UE 115-b and a network entity 105-b, which may be examples of corresponding devices described with reference to FIGS. 1 and 2. In some cases, the process flow 300 may support the UE 115-b transitioning between one or more sub-states of an RRC connected state according to an availability of location information at the UE 115-b, where the UE 115-b may support maintaining uplink synchronization with the network entity 105-b according to respective procedures associated with the sub-states. Alternative examples of the following may be implemented, where some processes are performed in a different order than described or are not performed. In some cases, processes may include additional features not mentioned below, or further processes may be added.

At 305, the UE 115-b may operate in an RRC connected state with the network entity 105-b. For example, the UE 115-b may communicate uplink signals to the network entity 105-b based on operating in the RRC connected state.

At 310, the network entity 105-b may transmit configuration information to the UE 115-b. In some cases, the configuration information may indicate a first uplink synchronization procedure and a second uplink synchronization procedure. In some cases, the first uplink synchronization procedure may be associated with a first set of time-frequency adjustment parameters (e.g., both time and frequency adjustments, for GNSS being unavailable) and the second uplink synchronization procedure may be associated with a second set of time-frequency adjustment parameters (e.g., timing adjustments for GNSS being available). For example, the first uplink synchronization procedure may be configured for use by the UE 115-b to maintain uplink synchronization with the network entity 105-b while the UE 115-b operates in a first sub-state of the RRC connected state and the second uplink synchronization procedure may be configured for use by the UE 115-b to maintain uplink synchronization with the network entity 105-b while the UE 115-b operates in a second sub-state of the RRC connected state. As described herein, the first sub-state of the RRC connected state may be associated with location information being unavailable at the UE 115-b and the second sub-state of the RRC connected state may be associated with location information being available at the UE 115-b. Additionally, or alternatively, the configuration information may indicate a duration of a first timer associated with the UE 115-b transitioning RRC sub-states when the UE 115-b identifies that location information is unavailable. For example, the configuration information may indicate, in a SIB, a duration that is common to one or more other UEs 115. Alternatively, the configuration may indicate, via RRC signaling, a duration that is specific to the UE 115-b and configured according to capabilities of the UE 115-b. In some other cases, the UE 115-b may determine the duration of the first timer according to an implementation of the UE 115-b.

At 315, the UE 115-b may determine a location status of the UE 115-b. For example, the UE 115-b may determine that location information for the UE 115-b is unavailable. In some cases, the UE 115-b may determine that the location information is unavailable based on losing a connection with a positioning system, such as a GNSS. For example, the UE 115-b may include a position engine operable to obtain measurements from an NTN that supports the UE 115-b identifying a physical location of the UE 115-b, and the UE 115-b may determine that the location information is unavailable based on failing to obtain one or more measurements. In some examples, the UE 115-b may use the location information to calculate timing advance adjustment and frequency adjustment values for maintaining uplink synchronization with the network entity 105-b.

At 320, the UE 115-b may initiate the first timer. In some cases, the first timer may have the duration indicated by the configuration information or determined by the UE 115-b. In some cases, the first timer may be associated with a validity of GNSS measurements. For example, while the first timer is running, the UE 115-b may use previous GNSS measurements (e.g., prior to losing the GNSS connection) to maintain approximate uplink synchronization with the network entity 105-b. Additionally, the UE 115-b may operate in the second sub-state of the RRC connected state (e.g., associated with GNSS being available) while the first timer is running.

At 325, the UE 115-b may transmit a first message to the network entity 105-b indicating a location status of the UE 115-b. For example, the first message may indicate that the location information associated with the UE 115-b is unavailable. In some cases, the UE 115-b may transmit the first message prior to the expiration of the first timer (e.g., in response to determining the location information is unavailable at 315).

At 330, the UE 115-b may initiate a second timer. In some cases, the UE 115-b may initiate the second timer based on transmitting the location status indication at 325. The second timer may indicate a duration between the UE 115-b transmitting location status indications. For example, if the UE 115-b identifies that the location information becomes available while the second timer is running, the UE 115-b may refrain from notifying the network entity 105-b until expiration of the second timer (e.g., to prevent frequent location status reporting, thereby mitigating signaling overhead).

At 335, the UE 115-b may receive control signaling from the network entity 105-b based on transmitting the location status indication. In one example, the control signaling may include an uplink synchronization adjustment command, which may indicate for the UE 115-b to use the first uplink synchronization procedure associated with the first sub-state of the RRC connected state. For example, the UE 115-b may use a first timing advance adjustment and a first frequency advance adjustment indicated by the uplink synchronization command to communicate one or more uplink signals via one or more slots (e.g., beginning at a first valid slot indicated by the command). In some cases, the UE 115-b may determine the first timing advance adjustment and the first frequency adjustment according to a feedback loop, where the feedback loop may be initialized based on a second timing advance adjustment and a second frequency adjustment used prior to the determination that the location information is unavailable (e.g., leveraging previous GNSS measurements to compute appropriate adjustment values). In such examples, the UE 115-b may stop the first timer and may remain in the second sub-state of the RRC connected state.

In another example, the control signaling may include a command to perform a RACH procedure via a first set of time-frequency resources. For example, the first set of time-frequency resources may be associated with a PRACH configured for operations in the first sub-state of the RRC connected state (e.g., configured for use when location information is unavailable). In such examples, the UE 115-b may perform the RACH procedure using the first set of time-frequency resources to maintain uplink synchronization with the network entity 105-b while the location information is unavailable.

In another example, the UE 115-b may not receive control signaling from the network entity 105-b at 335, and may maintain uplink synchronization according to a last-computed adjustment value. For example, while the first timer is running the UE 115-b may determine that the last-computed adjustment value (e.g., timing advance adjustment, frequency adjustment, or both) is valid for maintaining uplink synchronization, and may compute a new adjustment value according to the last-computed adjustment value to maintain uplink synchronization.

At 340, the UE 115-b may declare RLF based on a timing alignment timer (which may be referred to as a second timer) expiring. For example, if the UE 115-b loses the timing alignment timer while the first timer is running (e.g., the UE 115-b loses uplink synchronization), the UE 115-b may declare RLF and may perform a RACH procedure to regain the RRC connected status with the network entity 105-b. The UE 115-b may perform the RACH procedure via the first set of time-frequency resources configured for use while the location information is unavailable.

At 345, the UE 115-b may transition from the second sub-state of the RRC connected state to the first sub-state of the RRC connected state. In some cases, the UE 115-b may transition sub-states based on expiration of the first timer. In some cases, the network entity 105-b may be unaware that the UE 115-b has entered the first sub-state (e.g., the network entity 105-b may operate assuming the UE 115-b has available location information). In some examples, after transitioning sub-states, the UE 115-b may autonomously perform a RACH procedure using the first set of time-frequency resources configured for use while the location information is unavailable. Alternatively, the UE 115-b may perform the RACH procedure in response to a command to perform the RACH procedure in the control signaling at 335. In some other examples, the UE 115-b may maintain uplink synchronization according to the timing advance adjustment and frequency advance adjustment values indicated by the control signaling at 335.

At 350, the UE 115-b may determine the location status of the UE 115-b. For example, the UE 115-b may determine that the location information associated with the UE 115-b is available (e.g., the UE 115-b regains the GNSS connection). In some examples, the UE 115-b may determine that the location information is available while operating in the first sub-state of the RRC connected state.

At 355, the UE 115-b may transmit a second message to the network entity 105-b indicating the location status of the UE 115-b. The second message may indicate that the location information is available. In some cases, the UE 115-b may refrain from transmitting the second message until expiration of the second timer (e.g., the timer indicating the duration between transmitting location status indications).

At 360, the network entity 105-b may transmit control signaling to the UE 115-b in response to receiving the location status indication at 355. In some examples, the control signaling may include a command to perform a RACH procedure using a second set of time-frequency resources that are associated with a PRACH configured for operations in the second sub-state of the RRC connected state (e.g., RACH resources associated with the location information being available). In some other examples, the control signaling may include an uplink synchronization adjustment command indicating the second set of time-frequency adjustment values (e.g., associated with the location information being available, the second uplink synchronization procedure) for the UE 115-b to use for one or more slots.

At 365, the UE 115-b may communicate one or more uplink signals with the network entity 105-b. In some cases, the UE 115-b may apply timing advance adjustments, frequency adjustments, or both according to the uplink synchronization with the network entity 105-b. For example, the UE 115-b may apply the first set of time-frequency adjustment parameters associated with the first uplink synchronization procedure if the location information is unavailable or may apply the second set of time-frequency adjustment parameters associated with the second uplink synchronization procedure if the location information is available.

By operating in the different sub-states of the RRC connected state and maintaining timers supporting transitions between the sub-states, the UE 115-b may support two methods for uplink synchronization, one according to GNSS being unavailable and one according to GNSS being available. Such techniques may support the UE 115-b switching between the sub-states of the RRC connected state according to the timers and indications from the network entity 105-b, which may support the UE 115-b maintaining uplink synchronization without transitioning from the RRC connected state (e.g., even when location information is unavailable).

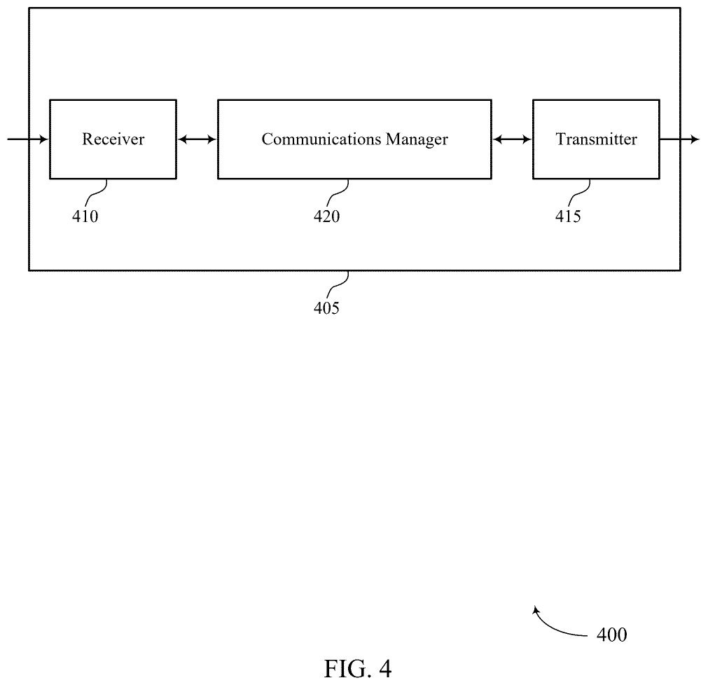

FIG. 4 shows a block diagram 400 of a device 405 that supports techniques for handling loss of positioning information in a connected state in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for handling loss of positioning information in a connected state). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for handling loss of positioning information in a connected state). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for handling loss of positioning information in a connected state as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for operating in an RRC connected state with a second network entity. The communications manager 420 is capable of, configured to, or operable to support a means for determining that location information associated with the first network entity is unavailable. The communications manager 420 is capable of, configured to, or operable to support a means for initiating a first timer based on a determination that the location information is unavailable. The communications manager 420 is capable of, configured to, or operable to support a means for transitioning to a first sub-state of the RRC connected state from a second sub-state of the RRC connected state based on expiration of the first timer, where the first sub-state is associated with the location information being unavailable and the second sub-state is associated with the location information being available. The communications manager 420 is capable of, configured to, or operable to support a means for communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reducing signaling overhead and latency associated with regaining an RRC connected status after losing location information by operating in different sub-states of the RRC connected state.

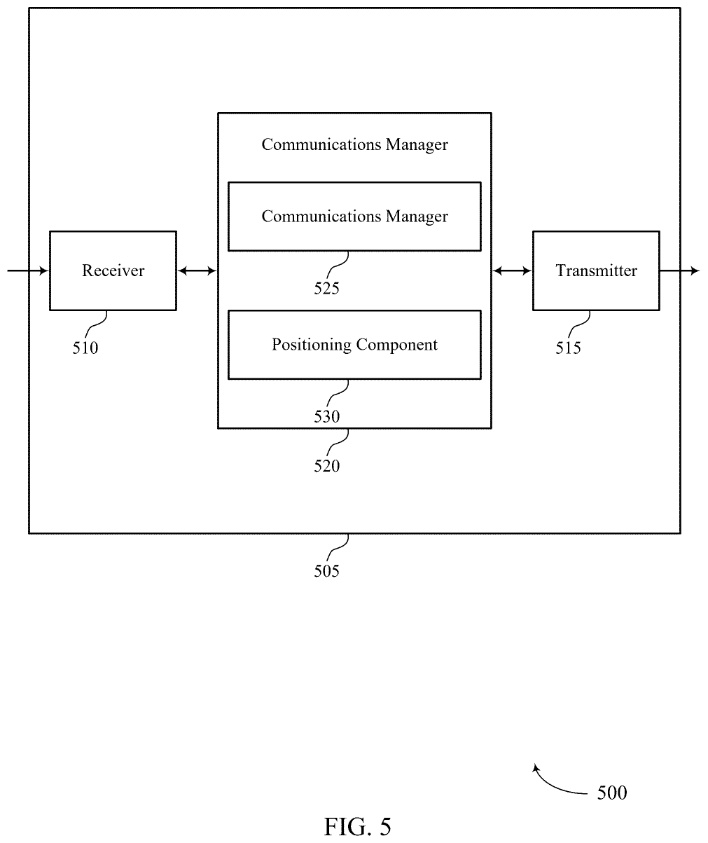

FIG. 5 shows a block diagram 500 of a device 505 that supports techniques for handling loss of positioning information in a connected state in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for handling loss of positioning information in a connected state). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for handling loss of positioning information in a connected state). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for handling loss of positioning information in a connected state as described herein. For example, the communications manager 520 may include a communications manager 525 a positioning component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The communications manager 525 is capable of, configured to, or operable to support a means for operating in an RRC connected state with a second network entity. The positioning component 530 is capable of, configured to, or operable to support a means for determining that location information associated with the first network entity is unavailable. The communications manager 525 is capable of, configured to, or operable to support a means for initiating a first timer based on a determination that the location information is unavailable. The communications manager 525 is capable of, configured to, or operable to support a means for transitioning to a first sub-state of the RRC connected state from a second sub-state of the RRC connected state based on expiration of the first timer, where the first sub-state is associated with the location information being unavailable and the second sub-state is associated with the location information being available. The communications manager 525 is capable of, configured to, or operable to support a means for communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

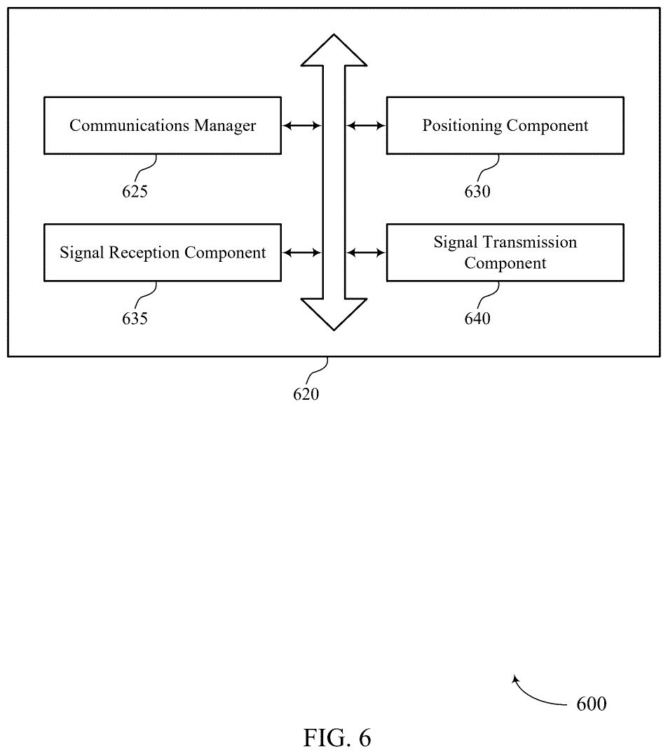

FIG. 6 shows a block diagram 600 of a communications manager 620 that supports techniques for handling loss of positioning information in a connected state in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for handling loss of positioning information in a connected state as described herein. For example, the communications manager 620 may include a communications manager 625, a positioning component 630, a signal reception component 635, a signal transmission component 640, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The communications manager 625 is capable of, configured to, or operable to support a means for operating in an RRC connected state with a second network entity. The positioning component 630 is capable of, configured to, or operable to support a means for determining that location information associated with the first network entity is unavailable. In some examples, the communications manager 625 is capable of, configured to, or operable to support a means for initiating a first timer based on a determination that the location information is unavailable. In some examples, the communications manager 625 is capable of, configured to, or operable to support a means for transitioning to a first sub-state of the RRC connected state from a second sub-state of the RRC connected state based on expiration of the first timer, where the first sub-state is associated with the location information being unavailable and the second sub-state is associated with the location information being available. In some examples, the communications manager 625 is capable of, configured to, or operable to support a means for communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

In some examples, the signal reception component 635 is capable of, configured to, or operable to support a means for receiving configuration information that indicates a first set of time-frequency adjustment parameters associated with the first uplink synchronization procedure and a second set of time-frequency adjustment parameters associated with a second uplink synchronization procedure, where the second uplink synchronization procedure is configured for use by the first network entity to maintain the uplink synchronization with the second network entity while the first network entity operates in the second sub-state of the RRC connected state.

In some examples, the signal reception component 635 is capable of, configured to, or operable to support a means for receiving configuration information that indicates a duration of the first timer, where the duration is common to a set of one or more network entities that includes the first network entity or the duration is configured in accordance with one or more capabilities of the first network entity.

In some examples, the signal transmission component 640 is capable of, configured to, or operable to support a means for transmitting, to the second network entity and prior to the expiration of the first timer, a first message that indicates that the location information associated with the first network entity is unavailable.

In some examples, the signal reception component 635 is capable of, configured to, or operable to support a means for receiving an uplink synchronization adjustment command from the second network entity based on transmission of the first message, where, to communicate with the second network entity in accordance with the first uplink synchronization procedure, the processing system is configured to. In some examples, the signal transmission component 640 is capable of, configured to, or operable to support a means for communicating one or more uplink signals via one or more slots in accordance with a first timing advance adjustment and a first frequency adjustment indicated by the uplink synchronization adjustment command.

In some examples, to support communicating the one or more uplink signals, the communications manager 625 is capable of, configured to, or operable to support a means for determining the first timing advance adjustment and the first frequency adjustment according to a feedback loop, where the feedback loop is initialized based on a second timing advance adjustment and a second frequency adjustment used prior to the determination that the location information is unavailable.

In some examples, the signal reception component 635 is capable of, configured to, or operable to support a means for receiving, from the second network entity and based on transmission of the first message, a second message that includes a command to perform a random access procedure via a first set of time-frequency resources, where the first set of time-frequency resources are associated with a PRACH configured for operations in the first sub-state of the RRC connected state.

In some examples, the communications manager 625 is capable of, configured to, or operable to support a means for initiating a second timer based on transmission of the first message. In some examples, the communications manager 625 is capable of, configured to, or operable to support a means for determining, prior to expiration of the second timer and while the first network entity operates in the first sub-state of the RRC connected state, that the location information is available. In some examples, the signal transmission component 640 is capable of, configured to, or operable to support a means for transmitting, to the second network entity, a second message that indicates that the location information is available based on the determination that the location information is available and expiration of the second timer.

In some examples, the communications manager 625 is capable of, configured to, or operable to support a means for refraining from transmission of the second message based on the second timer not being expired.

In some examples, the signal reception component 635 is capable of, configured to, or operable to support a means for receiving, from the second network entity and based on transmission of the second message, a third message that includes a timing adjustment associated with the second uplink synchronization procedure.

In some examples, the signal reception component 635 is capable of, configured to, or operable to support a means for receiving, from the second network entity and based on transmission of the second message, a third message that includes a command to perform a random access procedure via a second set of time-frequency resources, where the second set of time-frequency resources are associated with a PRACH configured for operations in the second sub-state of the RRC connected state.

In some examples, to support communicating with the second network entity in accordance with the first uplink synchronization procedure, the communications manager 625 is capable of, configured to, or operable to support a means for determining a first timing advance for communication of an uplink signal based on a second timing advance used prior to the determination that the location information is unavailable.

In some examples, the communications manager 625 is capable of, configured to, or operable to support a means for determining that a second timer associated with the uplink synchronization between the first network entity and the second network entity has expired. In some examples, the communications manager 625 is capable of, configured to, or operable to support a means for determining that RLF has occurred at the first network entity. In some examples, the communications manager 625 is capable of, configured to, or operable to support a means for performing a random access procedure via a first set of time-frequency resources based on the RLF.

In some examples, the signal reception component 635 is capable of, configured to, or operable to support a means for obtaining one or more measurements from a non-terrestrial navigation network, where the determination that the location information is unavailable is based on the one or more measurements.

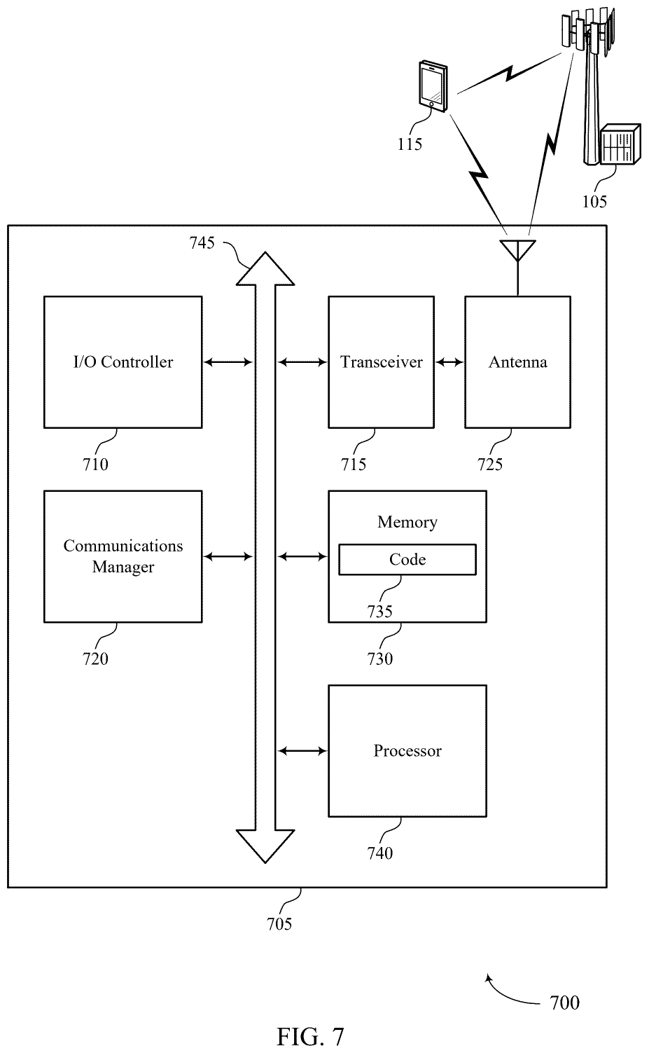

FIG. 7 shows a diagram of a system 700 including a device 705 that supports techniques for handling loss of positioning information in a connected state in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for handling loss of positioning information in a connected state). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for operating in an RRC connected state with a second network entity. The communications manager 720 is capable of, configured to, or operable to support a means for determining that location information associated with the first network entity is unavailable. The communications manager 720 is capable of, configured to, or operable to support a means for initiating a first timer based on a determination that the location information is unavailable. The communications manager 720 is capable of, configured to, or operable to support a means for transitioning to a first sub-state of the RRC connected state from a second sub-state of the RRC connected state based on expiration of the first timer, where the first sub-state is associated with the location information being unavailable and the second sub-state is associated with the location information being available. The communications manager 720 is capable of, configured to, or operable to support a means for communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state.

By including or configuring the communications manager 720 in accordance with examples as described herein, the device 705 may support techniques for reducing signaling overhead and latency associated with regaining an RRC connected status after losing location information by operating in different sub-states of the RRC connected state.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for handling loss of positioning information in a connected state as described herein, or the at least one processor 740 and the at least one memory 730 may be otherwise configured to, individually or collectively, perform or support such operations.

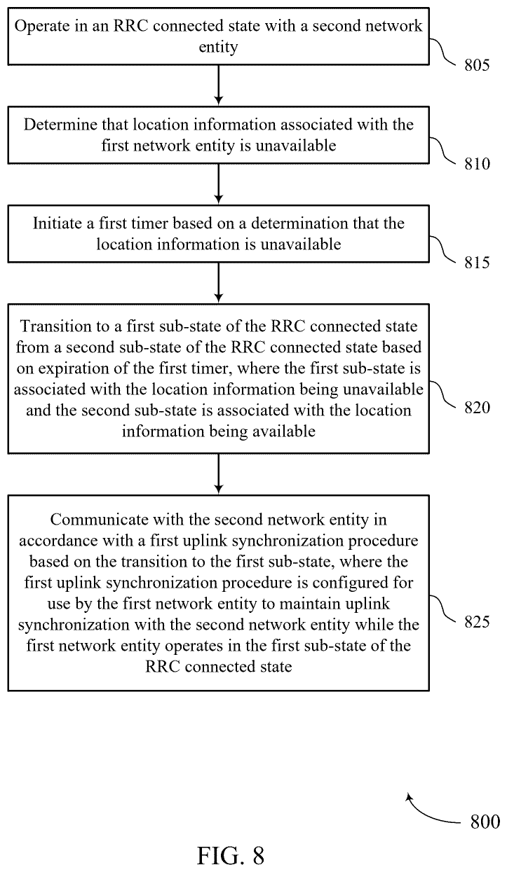

FIG. 8 shows a flowchart illustrating a method 800 that supports techniques for handling loss of positioning information in a connected state in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include operating in an RRC connected state with a second network entity. The operations of 805 may be performed in accordance with examples as disclosed herein. In some examples, aspects of the operations of 805 may be performed by a communications manager 625 as described with reference to FIG. 6.

At 810, the method may include determining that location information associated with the first network entity is unavailable. The operations of 810 may be performed in accordance with examples as disclosed herein. In some examples, aspects of the operations of 810 may be performed by a positioning component 630 as described with reference to FIG. 6.

At 815, the method may include initiating a first timer based on a determination that the location information is unavailable. The operations of 815 may be performed in accordance with examples as disclosed herein. In some examples, aspects of the operations of 815 may be performed by a communications manager 625 as described with reference to FIG. 6.

At 820, the method may include transitioning to a first sub-state of the RRC connected state from a second sub-state of the RRC connected state based on expiration of the first timer, where the first sub-state is associated with the location information being unavailable and the second sub-state is associated with the location information being available. The operations of 820 may be performed in accordance with examples as disclosed herein. In some examples, aspects of the operations of 820 may be performed by a communications manager 625 as described with reference to FIG. 6.

At 825, the method may include communicating with the second network entity in accordance with a first uplink synchronization procedure based on the transition to the first sub-state, where the first uplink synchronization procedure is configured for use by the first network entity to maintain uplink synchronization with the second network entity while the first network entity operates in the first sub-state of the RRC connected state. The operations of 825 may be performed in accordance with examples as disclosed herein. In some examples, aspects of the operations of 825 may be performed by a communications manager 625 as described with reference to FIG. 6.

The following provides an overview of aspects of the present disclosure:
Aspect 1: A method for wireless communication at a first network entity, comprising: operating in an RRC connected state with a second network entity; determining that location information associated with the first network entity is unavailable; initiating a first timer based on a determination that the location information is unavailable; transitioning to a first sub-state of the RRC connected state from a second sub-state of the RRC connected state based on expiration of the first timer, wherein the first sub-state is associated with the location information being unavailable and the second sub-state is associated with the location information being available; and communicating with the second network entity in accordance with a first uplink synchronization procedure based on the transition to the first sub-state, wherein the first uplink synchronization procedure is configured for use by the first network entity to maintain uplink synchronization with the second network entity while the first network entity operates in the first sub-state of the RRC connected state.
Aspect 2: The method of aspect 1, further comprising: receiving configuration information that indicates a first set of time-frequency adjustment parameters associated with the first uplink synchronization procedure and a second set of time-frequency adjustment parameters associated with a second uplink synchronization procedure, wherein the second uplink synchronization procedure is configured for use by the first network entity to maintain the uplink synchronization with the second network entity while the first network entity operates in the second sub-state of the RRC connected state.
Aspect 3: The method of any of aspects 1 through 2, further comprising: receiving configuration information that indicates a duration of the first timer, wherein the duration is common to a set of one or more network entities that comprises the first network entity or the duration is configured in accordance with one or more capabilities of the first network entity.
Aspect 4: The method of any of aspects 1 through 3, further comprising: transmitting, to the second network entity and prior to the expiration of the first timer, a first message that indicates that the location information associated with the first network entity is unavailable.
Aspect 5: The method of aspect 4, wherein receiving an uplink synchronization adjustment command from the second network entity based on transmission of the first message, wherein communicating with the second network entity in accordance with the first uplink synchronization procedure comprises: communicating one or more uplink signals via one or more slots in accordance with a first timing advance adjustment and a first frequency adjustment indicated by the uplink synchronization adjustment command.
Aspect 6: The method of aspect 5, wherein communicating the one or more uplink signals comprises: determining the first timing advance adjustment and the first frequency adjustment according to a feedback loop, wherein the feedback loop is initialized based on a second timing advance adjustment and a second frequency adjustment used prior to the determination that the location information is unavailable.
Aspect 7: The method of any of aspects 4 through 6, further comprising: receiving, from the second network entity and based on transmission of the first message, a second message that comprises a command to perform a random access procedure via a first set of time-frequency resources, wherein the first set of time-frequency resources are associated with a PRACH configured for operations in the first sub-state of the RRC connected state.
Aspect 8: The method of any of aspects 4 through 7, further comprising: initiating a second timer based on transmission of the first message; determining, prior to expiration of the second timer and while the first network entity operates in the first sub-state of the RRC connected state, that the location information is available; and transmitting, to the second network entity, a second message that indicates that the location information is available based on the determination that the location information is available and expiration of the second timer.
Aspect 9: The method of aspect 8, further comprising: refraining from transmission of the second message based on the second timer not being expired.
Aspect 10: The method of any of aspects 8 through 9, further comprising: receiving, from the second network entity and based on transmission of the second message, a third message that comprises a timing adjustment associated with the second uplink synchronization procedure.
Aspect 11: The method of any of aspects 8 through 9, further comprising: receiving, from the second network entity and based on transmission of the second message, a third message that comprises a command to perform a random access procedure via a second set of time-frequency resources, wherein the second set of time-frequency resources are associated with a PRACH configured for operations in the second sub-state of the RRC connected state.
Aspect 12: The method of any of aspects 4 through 11, wherein communicating with the second network entity in accordance with the first uplink synchronization procedure comprises: determining a first timing advance for communication of an uplink signal based on a second timing advance used prior to the determination that the location information is unavailable.
Aspect 13: The method of any of aspects 1 through 12, further comprising: determining that a second timer associated with the uplink synchronization between the first network entity and the second network entity has expired; determining that RLF has occurred at the first network entity; and performing a random access procedure via a first set of time-frequency resources based on the RLF.
Aspect 14: The method of any of aspects 1 through 13, further comprising: obtaining one or more measurements from a non-terrestrial navigation network, wherein the determination that the location information is unavailable is based on the one or more measurements.
Aspect 15: A first network entity for wireless communication, comprising one or more memories storing processor-executable code, and one or more processors coupled with the one or more memories and individually or collectively operable to execute the code to cause the first network entity to perform a method of any of aspects 1 through 14.
Aspect 16: A first network entity for wireless communication, comprising at least one means for performing a method of any of aspects 1 through 14.
Aspect 17: A non-transitory computer-readable medium storing code for wireless communication, the code comprising instructions executable by one or more processors to perform a method of any of aspects 1 through 14.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of”.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
operate in a radio resource control (RRC) connected state with a second network entity;
determine that location information associated with the first network entity is unavailable;
initiate a first timer based on a determination that the location information is unavailable;
transition to a first sub-state of the RRC connected state from a second sub-state of the RRC connected state based on expiration of the first timer, wherein the first sub-state is associated with the location information being unavailable and the second sub-state is associated with the location information being available; and
communicate with the second network entity in accordance with a first uplink synchronization procedure based on the transition to the first sub-state, wherein the first uplink synchronization procedure is configured for use by the first network entity to maintain uplink synchronization with the second network entity while the first network entity operates in the first sub-state of the RRC connected state.

2. The first network entity of claim 1, wherein the processing system is configured to:
receive configuration information that indicates a first set of time-frequency adjustment parameters associated with the first uplink synchronization procedure and a second set of time-frequency adjustment parameters associated with a second uplink synchronization procedure, wherein the second uplink synchronization procedure is configured for use by the first network entity to maintain the uplink synchronization with the second network entity while the first network entity operates in the second sub-state of the RRC connected state.

3. The first network entity of claim 1, wherein the processing system is configured to:
receive configuration information that indicates a duration of the first timer, wherein the duration is common to a set of one or more network entities that comprises the first network entity or the duration is configured in accordance with one or more capabilities of the first network entity.

4. The first network entity of claim 1, wherein the processing system is configured to:
transmit, to the second network entity and prior to the expiration of the first timer, a first message that indicates that the location information associated with the first network entity is unavailable.

5. The first network entity of claim 4, wherein the processing system is configured to:
receive an uplink synchronization adjustment command from the second network entity based on transmission of the first message, wherein, to communicate with the second network entity in accordance with the first uplink synchronization procedure, the processing system is configured to:
communicate one or more uplink signals via one or more slots in accordance with a first timing advance adjustment and a first frequency adjustment indicated by the uplink synchronization adjustment command.

6. The first network entity of claim 5, wherein, to communicate the one or more uplink signals, the processing system is configured to:
determine the first timing advance adjustment and the first frequency adjustment according to a feedback loop, wherein the feedback loop is initialized based on a second timing advance adjustment and a second frequency adjustment used prior to the determination that the location information is unavailable.

7. The first network entity of claim 4, wherein the processing system is configured to:
receive, from the second network entity and based on transmission of the first message, a second message that comprises a command to perform a random access procedure via a first set of time-frequency resources, wherein the first set of time-frequency resources are associated with a physical random access channel configured for operations in the first sub-state of the RRC connected state.

8. The first network entity of claim 4, wherein the processing system is configured to:
initiate a second timer based on transmission of the first message;
determine, prior to expiration of the second timer and while the first network entity operates in the first sub-state of the RRC connected state, that the location information is available; and
transmit, to the second network entity, a second message that indicates that the location information is available based on the determination that the location information is available and expiration of the second timer.

9. The first network entity of claim 8, wherein the processing system is configured to:
refrain from transmission of the second message based on the second timer not being expired.

10. The first network entity of claim 8, wherein the processing system is configured to:
receive, from the second network entity and based on transmission of the second message, a third message that comprises a timing adjustment associated with the second uplink synchronization procedure.

11. The first network entity of claim 8, wherein the processing system is configured to:
receive, from the second network entity and based on transmission of the second message, a third message that comprises a command to perform a random access procedure via a second set of time-frequency resources, wherein the second set of time-frequency resources are associated with a physical random access channel configured for operations in the second sub-state of the RRC connected state.

12. The first network entity of claim 4, wherein, to communicate with the second network entity in accordance with the first uplink synchronization procedure, the processing system is configured to:
determine a first timing advance for communication of an uplink signal based on a second timing advance used prior to the determination that the location information is unavailable.

13. The first network entity of claim 1, wherein the processing system is configured to:
determine that a second timer associated with the uplink synchronization between the first network entity and the second network entity has expired;
determine that radio link failure has occurred at the first network entity; and
perform a random access procedure via a first set of time-frequency resources based on the radio link failure.

14. The first network entity of claim 1, further comprising:
a position engine operable to obtain one or more measurements from a non-terrestrial navigation network, wherein the determination that the location information is unavailable is based on the one or more measurements.

15. A method for wireless communication at a first network entity, comprising:
operating in a radio resource control (RRC) connected state with a second network entity;
determining that location information associated with the first network entity is unavailable;
initiating a first timer based on a determination that the location information is unavailable;
transitioning to a first sub-state of the RRC connected state from a second sub-state of the RRC connected state based on expiration of the first timer, wherein the first sub-state is associated with the location information being unavailable and the second sub-state is associated with the location information being available; and
communicating with the second network entity in accordance with a first uplink synchronization procedure based on the transition to the first sub-state, wherein the first uplink synchronization procedure is configured for use by the first network entity to maintain uplink synchronization with the second network entity while the first network entity operates in the first sub-state of the RRC connected state.

16. The method of claim 15, further comprising:
receiving configuration information that indicates a first set of time-frequency adjustment parameters associated with the first uplink synchronization procedure and a second set of time-frequency adjustment parameters associated with a second uplink synchronization procedure, wherein the second uplink synchronization procedure is configured for use by the first network entity to maintain the uplink synchronization with the second network entity while the first network entity operates in the second sub-state of the RRC connected state.

17. The method of claim 15, further comprising:
receiving configuration information that indicates a duration of the first timer, wherein the duration is common to a set of one or more network entities that comprises the first network entity or the duration is configured in accordance with one or more capabilities of the first network entity.

18. The method of claim 15, further comprising:
transmitting, to the second network entity and prior to the expiration of the first timer, a first message that indicates that the location information associated with the first network entity is unavailable.

19. The method of claim 18, further comprising:
receiving an uplink synchronization adjustment command from the second network entity based on transmission of the first message, wherein communicating with the second network entity in accordance with the first uplink synchronization procedure comprises:
communicating one or more uplink signals via one or more slots in accordance with a first timing advance adjustment and a first frequency adjustment indicated by the uplink synchronization adjustment command.

20. A non-transitory computer-readable medium storing code for wireless communication, the code comprising instructions executable by one or more processors of a first network entity to:
operate in a radio resource control (RRC) connected state with a second network entity;
determine that location information associated with the first network entity is unavailable;
initiate a first timer based on a determination that the location information is unavailable;
transition to a first sub-state of the RRC connected state from a second sub-state of the RRC connected state based on expiration of the first timer, wherein the first sub-state is associated with the location information being unavailable and the second sub-state is associated with the location information being available; and
communicate with the second network entity in accordance with a first uplink synchronization procedure based on the transition to the first sub-state, wherein the first uplink synchronization procedure is configured for use by the first network entity to maintain uplink synchronization with the second network entity while the first network entity operates in the first sub-state of the RRC connected state.
